(19) United States
(12) Patent Application Publication
(10) Pub. No.: US 2008/0115431 A1
(43) Pub. Date: May 22, 2008

(54) APPARATUS AND METHOD FOR FORMING AN OPENING IN A CONCRETE WALL SYSTEM

(75) Inventor: Alan Mill, Fort Collins, CO (US)

Correspondence Address: SHERIDAN ROSS PC, 1560 BROADWAY, SUITE 1200, DENVER, CO, 80202, US

(73) Assignee: 2M SQUARED LLC, Fort Collins, CO (US)

(21) Appl. No.: 11/941,243

(22) Filed: Nov. 16, 2007

Related U.S. Application Data
(60) Provisional application No. 60/866,385, filed on Nov. 17, 2006.

(51) Int. Cl. E06B 1/04

(52) U.S. Cl. 52/215

(57) ABSTRACT

A method and apparatus for forming an opening in a concrete wall is provided. More specifically, interlocking concrete forms comprising parallel spaced insulation panels are provided for receipt of concrete. Any openings, i.e. such as for windows and doors, are accommodated within the insulated concrete forms by way of a customizable buck. The buck members utilize less material than those of the prior art, and are easily customized to yield a required opening size. The placement of concrete into the form yields a concrete wall with the desired window or door opening.

This application claims the benefit of U.S. Provisional Patent Application Ser. No. 60/866,365, filed Nov. 17, 2006, the entire disclosure of which is incorporated by reference herein.

### FIELD OF THE INVENTION

The present invention relates generally to a method and apparatus for forming a window or door opening in a concrete wall.

### BACKGROUND OF THE INVENTION

Pre-cast concrete wall panels or cast-in-place concrete walls often require window and door openings. One way to form a window or door opening is to cut and remove a section from the finished, cured wall which is costly and which can damage other portions of the wall. Alternatively, it is known to incorporate a void, i.e., a “buck”, into a concrete wall form to define the required opening in the wall panel. Bucks are usually transported to, or fabricated at, a construction site, in the case of a cast-in-place wall or, in the case of prefabricated wall panel construction, assembled at a factory. One drawback of bucks used today is that they are difficult to locate, are heavy, are size specific, are generally not insulated, and often wasteful. Further, bucks found in the art are often constructed of vinyl or non-eco-friendly wood products that include chemical additives to prevent wood degradation attributed to wood/concrete contact. Thus there is a long felt need in the field of concrete wall construction to provide a buck system that is easy to employ, is less wasteful, more ecological, and can be quickly and accurately formed and assembled on the construction site.

### SUMMARY OF THE INVENTION

It is one aspect of the present invention to provide a customizable window and/or door buck. More specifically, embodiments of the present invention are constructed of members that are composed of wood and insulation that interconnect to form the window or door buck. In addition, the individual members of the window or door buck may be cut to any desired size thereby reducing waste and increasing design flexibility. More specifically, in the case of cast-in-place wall panel construction, often chemically treated wood, usually larger that what is required to form the members of a buck, are cut at the job site and assembled to form bucks wherein any excess wood is discarded. One advantage of embodiments of the present invention is that the individual buck members, as described in greater detail below, are assembled off-site using materials of dimensions that generally coincide with the desired window, door, or other opening shape wherein scrap at the jobsite is reduced or eliminated. More specifically, in the United States, timber is generally cut in the forest in 24 foot lengths. At the mill the timber is cut into three 8 foot lengths, an 8 foot and a 16 foot length, a 10 foot and a 14 foot length or two 12 foot lengths. These standard lengths must be modified at the job site to yield the desired opening wherein the excess is discarded. Conversely, the buck material of a customized length may be delivered to the job site and cut into separate buck members wherein the excess is significantly reduced. Embodiments of the present invention employ 47% less wood than bucks constructed of dimensional lumber. Furthermore, the buck members retain the advantages of wood, thereby facilitating sawing, drilling and general workability while being less expensive than wood alone or vinyl. The buck members are also eco-friendly because they eliminate the need for chemically treated wood products as the wood incorporated into the buck members does not contact the concrete. Another advantage of the buck members as described herein is that less heat transfer occurs because the buck material includes insulation as opposed to a wood/concrete interface. The present buck system is typically less costly, including material and labor costs, than buck systems of the prior art and provides greater design options.

It is another aspect of the present invention to provide bucks that may be employed in various concrete wall construction schemes, such as cast-in-place walls, prefabricated tilt-up walls (which may include a low density insulated core), or concrete walls that employ interlocking insulated concrete forms, as described in detail below. In the case of a cast-in-place wall, after a first wall form and associated reinforcement are located, the window buck is placed and secured to the reinforcing members and a second wall form. Yet another advantage of this building method, in addition to reduction in waste and omission of shims, is that workers can help ensure concrete is sufficiently placed under the window buck. More specifically, an aperture, in some embodiments about 1.5 to 6 inches in diameter, can be integrated on-site into a lower member of a buck to allow for vibrational concrete manipulation that causes the concrete to fill in the area under the window buck. The aperture can then be plugged to prevent excess concrete from escaping and/or to restore the continuity of the lower buck member.

One skilled in the art will appreciate that embodiments of the present invention may be incorporated into prefabricated concrete wall panels. For example, prior to placing the concrete into a horizontally-oriented form, a window buck may be located to define the desired window opening. Further, some embodiments of the present invention are adapted to be used with insulated panels spaced by a web. These insulated concrete forms (“ICF”) are usually light and stackable, thereby allowing workers to easily construct a wall of substantial size without the aid of heavy machinery. Embodiments of the present invention additionally provide a novel way of including a rebar securing member within the space between the two adjacent parallel insulation panels that make up the ICF.

It is yet another aspect of the invention to provide an indication of buck member length. That is, embodiments of the invention include ruled markings to help workers to easily estimate or customize the length of individual buck members prior to buck assembly. The markings maybe spaced in any common unit of length, including every inch, centimeter, yard, foot, meter, etc. In addition, other markings or colors may be employed to indicate size, such as buck depth, or to designate compatibility with other building materials, or to enhance assembly. Trademarks may also be included.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional or alternative aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a perspective view of a window buck of one embodiment of the present invention;

FIG. 2 is a front elevation view of a buck member;

FIG. 3 is a front elevation view of an alternate embodiment of the buck member shown in FIG. 2;

FIG. 4 is a front elevation view of an alternate embodiment of the buck member shown in FIG. 2;

FIG. 5 is a front elevation view of an alternate embodiment of the buck member shown in FIG. 2;

FIG. 6 is a front elevation view of an embodiment of an adjustable brace that may be used in conjunction with a window buck;

FIG. 7 is a perspective view of an insulated concrete form;

FIG. 8 is a front elevation view of the insulated concrete form shown in FIG. 7;

FIG. 9 is a top plan view of a strapping plate;

FIG. 10 is a front elevation view of the strapping plate of FIG. 9;

FIG. 11 is a perspective view of a rebar holder;

FIG. 12 is a front elevation view of a wall form comprising a plurality of insulated concrete forms around a window buck; and

FIG. 13 is a partial sectional view of the wall form shown in FIG. 12.

To assist in the understanding of the present invention the following list of components and associated numbering found in the drawings is provided herein:

| Component | # |
|---|---|
| Window buck | 2 |
| Upper Buck Member | 6 |
| Lower Buck Member | 10 |
| Lateral Buck Member | 14 |
| Brace | 18 |
| Adjustable Brace | 22 |
| Panel | 26 |
| Beam | 30 |
| Insulation | 34 |
| Keyway | 38 |
| Insulated Concrete Form | 42 |
| Insulation panel | 46 |
| Spacer Web | 50 |
| Tooth | 54 |
| Engineered Buck Material | 58 |
| Round | 62 |
| Fillets | 66 |
| Wall | 67 |
| Floor | 68 |
| Arcuate Channel | 70 |
| Spacer Web Face | 74 |
| Cavity | 78 |
| Strapping Plate | 82 |
| Aperture | 86 |
| Tab | 90 |
| Strap | 98 |
| Rebar Holder | 102 |
| Arcuate bend | 106 |
| Leg | 108 |
| Rebar | 110 |
| Wall | 114 |
| Void | 122 |
| Weld | 126 |
| Clamp fixture | 130 |
| Bar | 134 |
| Coupling | 138 |
| Plate | 142 |
| Outer pipe | 146 |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated or described herein.

### DETAILED DESCRIPTION

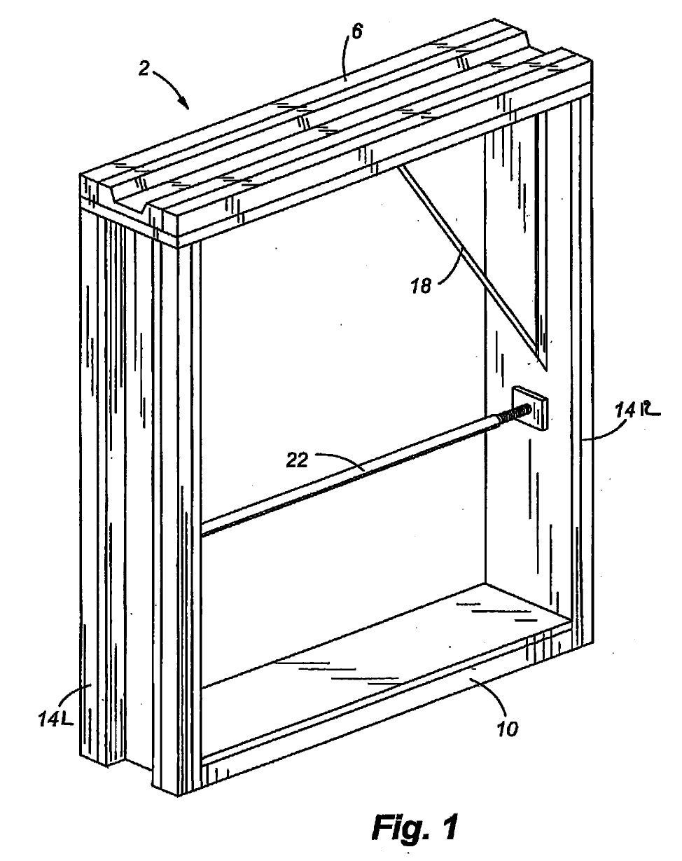

Referring now to FIGS. 1-13, a system for creating an opening in a concrete wall is provided. More specifically, a window buck 2 that is comprised of an upper buck member 6, a lower buck member 10 and two lateral buck members 14 positioned therebetween is generally provided. The buck members are maintained approximately square during forming with a brace 18. An adjustable brace 22 may also be employed to ensure that the lateral buck members 14 and/or the upper buck member 6 and the lower buck member 20 do not bow inward when concrete is placed into the form. The buck members are generally comprised of a panel 26 with beams 30 interconnected thereto via fasteners, adhesives, etc. However, the buck members may be formed from a unitary form or extruded. The space between the beams 30 contains an insulative material 34 that may include a keyway 38. The completed window buck 2 is integrated into a cast-in-place wall form, prefabricated tilt-up wall form, or into a system of interlocking insulated concrete forms 42. The insulated concrete forms 42 are generally comprised of two insulation panels 46 that are separated by a spacer web 50. The insulated concrete forms 42 may include teeth 54 and cavities 78 thereby facilitating interconnection between two adjoining insulated concrete forms 42.

Referring specifically now to FIG. 1, a window buck 2 is provided that is comprised of the upper buck member 6, the lower buck member 10, and the lateral buck members 14 positioned therebetween. In one embodiment the upper buck member 6 is longer than the lower buck member 10 such that the lower buck member 10 is positioned between the left lateral buck member 14L and the right lateral buck member 14R. The brace 18 may be used to ensure that the upper buck member 6 is aligned approximately 90 degrees relative to the lateral buck members 14. Once the buck members are placed in the correct orientation, i.e. “square”, the upper buck member 6 and lower buck member 10 are interconnected to the lateral buck members using screws, nails, glue, or any other fastening mechanism known in the art. The upper buck member 6, the lower buck member 10 and lateral buck members 14 are customizable wherein the lengths thereof may be selectively altered to form an opening of any size. An adjustable brace 22 may additionally be employed between two buck members, either horizontally, vertically or both, to resist the force of the concrete when it is placed in the form as explained in further detail below.

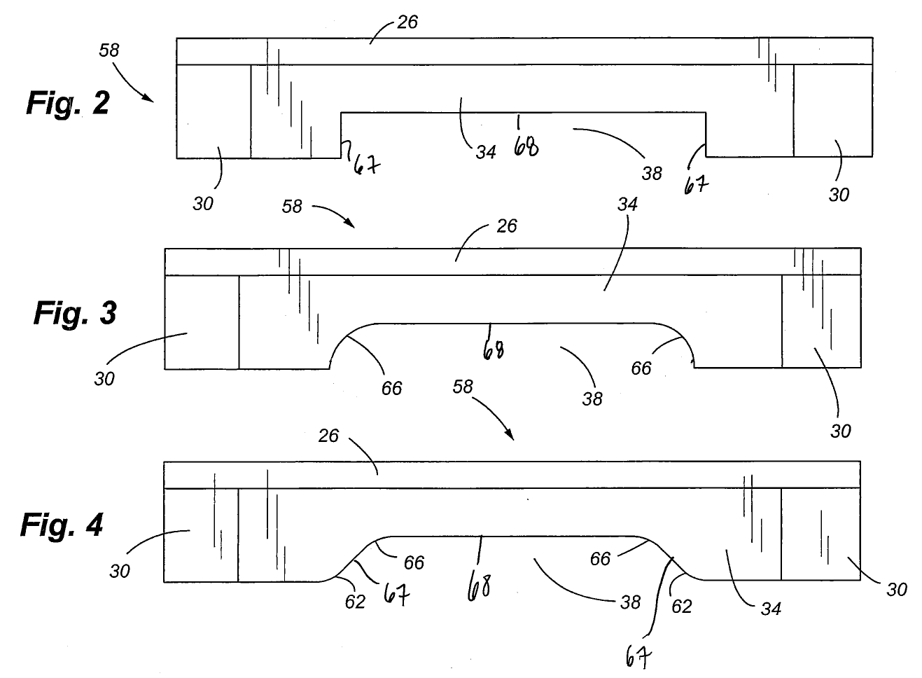

Referring now to FIGS. 2-5, front elevation views of engineered buck material 58 that comprise the upper buck member 6, the lower buck member 10 and the lateral buck members 14 is shown. The engineered buck material 58 is generally an assembly of a panel 26 with parallelly spaced beams 30. Insulation 34 is positioned between the beams 30, which may or may not include a cut-out, or keyway 38. The keyway may be a continuous cavity or a plurality of discreet openings positioned in the insulation. The keyway 38 eliminates the need for nails, bolts, or other members that are traditionally integrated into the window buck 2 to anchor the window buck 2 to the concrete. The keyway 38 allows concrete to extend into the window buck 2 and creates a sheer prevention mechanism. The keyway 38 of some embodiments of the present invention is generally rectangular, with rounds 62 or fillets 66 included therein or other shapes, as shown. Some panel insulation employed include a trapezoidal keyway 38, as shown in FIG. 5. The walls 67 of the keyway 38 are angled (θ) from about 90°-150°, and are preferably angled about 135°. One advantage of employing angled walls 67 oriented greater than about 90° from each other is that the probability of maintaining concrete within the entire keyway 38 is increased. Generally, in one embodiment, the keyway 38 is about 0.75 inches deep and is centered within the insulation wherein about a 1.5 inch span of insulation resides between each beam 30 and the keyway 38. One skilled in the art, however, will appreciate that the size of the insulation 34, and thus the keyway 38, may be scaled to any size to accommodate any wall size and/or thickness. It is also contemplated that the insulation 34 be comprised of distinct components that are associated with the beams 30, thereby exposing a portion of the panel 26. Further, the insulation 34 may be a multi-pieced assemblage.

The beams 30 in various embodiments of the present invention are preferably Laminated Strand Lumber (LSL) or Laminated Veneer Lumber (LVL) that are about 1 9/16 inches thick and about 1.25 inches wide. The LSL of embodiments of the present invention is an engineered lumber product provided by TrusJoint Products of Columbus, Ohio and sold under the trade name TimberStrand. The LVL of embodiments of the present invention is also provided by TrusJoist Products under the trade name Microllam. The panel 26 in various embodiments of the present invention is generally about 7/16 inches thick and about 8 to 15 inches wide. In one embodiment the panels are about 11 ½ inches wide. Thus the entire thickness of the engineered buck material 58 is about 2 inches. The total length of the engineered material 58 is customizable wherein the required length of each member is cut prior to incorporating with other buck members to form the desired opening. In certain embodiments of the present invention the panel 26 may be oriented strand board (OSB), or plywood, wood-plastic composite, and/or metal materials, the insulation 34 is expanded polystyrene (EPS) and the beams 30 are engineered LSL. One skilled in the art will appreciate that even though embodiments of the present invention employ materials as described above, any suitable building material may be used, including, but not limited to steel, plastic, aluminum, concrete, wood, plywood, extruded polystyrene, urethane, wood-plastic composites and/or a compilation thereof.

Referring now to FIGS. 1 and 6, an adjustable brace 22 of one embodiment of the present invention is shown. More specifically, the adjustable brace 22, which is adapted to be positioned between a left lateral buck member 14L and the right lateral buck member 14R is generally comprised of a bar 134 that is slidingly engaged to an outer pipe 146. Embodiments of the present also employ an adjustable brace 22 between the upper buck member 6 and the lower buck member 10, such an adjustable brace 22 can be employed alone as well. On one end of the outer pipe 146 is interconnected to a coupling 138 that is welded 142 to a plate 142L. The other end of the outer pipe 146 is welded 142 to a clamp fixture 130. The clamp fixture 130 is adapted to adjustably secure the bar 136. The other end of the bar is interconnected to a coupling 138 that is also welded 126 to a plate 142R. The plates 142 are adapted to be interconnected to the panel portions of the lateral buck members 14. Customization of the adjustable brace 22 is achieved by selectively engaging the bar 134 within the clamp fixture 130 to provide the length required. In embodiments of the present invention, the clamp fixture 130 is a Pony Style 52 clamp fixture for a half inch pipe sold by Jorgensen. The bar 134 is about ½ inch schedule 40 pipe having an about ⅞ inch outside diameter. The outer pipe 146 is one inch schedule 40 pipe having an about 1 ¼ outer diameter. The couplings 138 are either a one inch NPT coupling or a ½ inch NPT coupling depending on their interconnection to either the outer pipe 146 or the bar 134. The plates 142 are approximately 3×3 inch ×⅛ inch thick and have one or more holes positioned therein that allow for interconnection to the lateral buck members with nails, screws, bolts, etc. The adjustable brace 22 of this embodiment of the present invention allows for selectively adjustability wherein the clamp fixture 130 is welded to the outer pipe 146 between a range of about 20 ½ inches to 44 ½ inches from the plate 142L. The span from the end of the bar 134 to the end of the plate 142R is about 22-46 inches. Thus expandability of about 20 ½ inches to an about 90 ½ inches is provided by one embodiment. It is contemplated that the adjustable brace 22 may be scaled to any size to accommodate any size of window or door desired. For example, it is well within the scope of the present invention to provide an adjustable brace 22 that spans about 14-16 feet that are needed to form openings associated with a garage door.

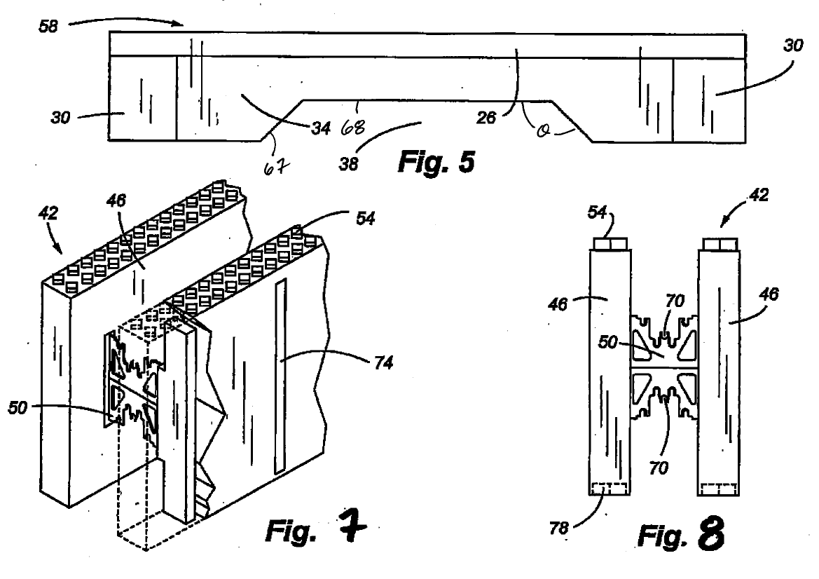

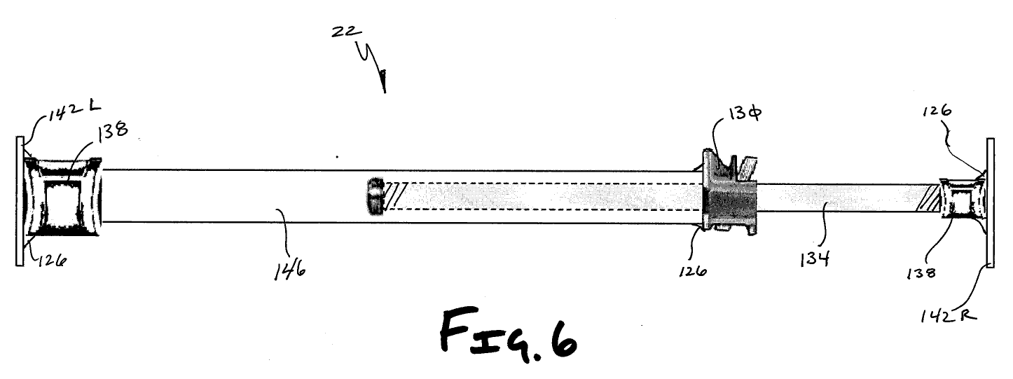

Referring now to FIGS. 7 and 8, one embodiment of an insulated concrete form (ICF) 42 is provided that includes parallel oriented and spaced insulation panels 46 that are separated with a spacer web 50. The spacer web 50 may provide a location for the securement of reinforcing bars, preferably within arcuate channels 70. The spacer webs 50 include faces 74 that extend through the insulation panels 46 and are visible on the outside of the insulation panel 46. In some instances the spacer web faces 74 are at least partially embedded into the insulation panels 46. Insulation panels 46 of embodiments of the present invention include teeth 54 and cavities 78 that provide an interlocking interconnection between two stacked or adjacently located insulated concrete forms 42. The figures presented herein show ICFs manufactured by Arxx Building Products, Inc. One skilled in the art will appreciate that the buck system of embodiments of the present invention may be incorporated into most any ICF such as those offered by Reward Wall Systems, Inc., Nudura Corporation, ECO-Block, LLC, Quad-Lock Building Systems, Ltd., American PolySteel, LLC. The Vertical ICF, Inc., and other manufacturers.

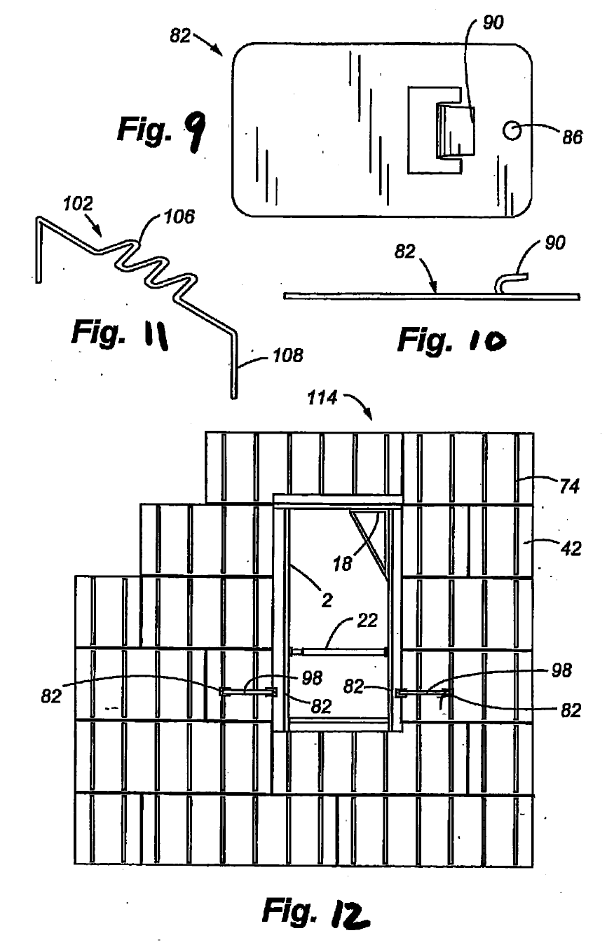

Referring now to FIGS. 9 and 10, a strapping plate 82 utilized in one embodiment of the present invention is shown. More specifically, the strapping plate 82 includes an aperture 86 and a tab 90. During form assembly, which will be described in further detail below, the aperture 86 receives a fastener and is interconnected to the spacer web face 74, which in some instances is located within the thickness of the insulation panel 46. A strap 98 is then interconnected to the tab 90 and to a strapping plate 82 that is interconnected similarly to the lateral buck member 14. Tensioning of the strap 98 firmly secures the insulated concrete form 42 to the buck 2. Alternatively, two straps can be employed or the strap could wrap around the inside of the buck and be attached to a strapping plate on the other side of the ICF.

Referring now specifically to FIG. 11, a rebar holder 102 is shown that is employed in some embodiments of the present invention. More specifically, the rebar holder 102 is generally a wire with a plurality of arcuate bends 106. In addition, the rebar holder includes generally straight legs 108 depending in a perpendicular direction from the portion shown. These legs 108 may include a sharp point for interconnection to the insulation panel material 46. Once the rebar holder 102 is firmly integrated into adjacent parallel insulation panels 46, the arcuate bends 106 are adapted to receive and secure a reinforcing member, i.e. “rebar” 110. The rebar 110 site generally being employed by some embodiments of the invention have an Imperial bar size of #4, #5 or #6, having a nominal diameter of about 0.5 in., 0.625 in., and 0.75 in. respectively. However, one skilled in the art will appreciate that aspects of the invention presented herein are not limited to any one size wherein any size rebar, or any other type of reinforcing member for that matter, may be employed.

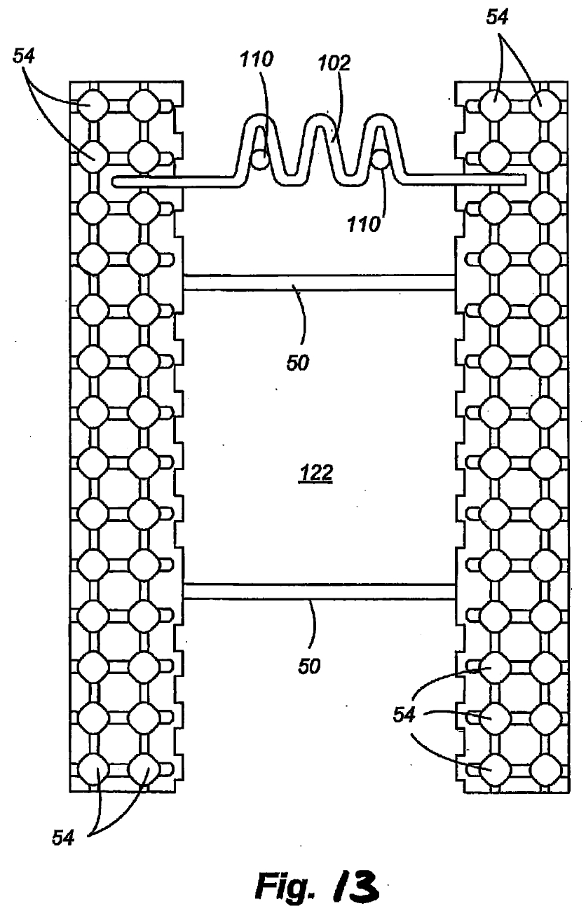

Referring now to FIGS. 12 and 13, the integration of a window buck 2 into a wall form 114 is shown. More specifically, here, a wall form 114 is provided that includes a plurality of interlocked ICFs 42. The window buck 2 is placed on the ICFs 42 and secured thereto by way of the strapping plates 82 and tensioned strap 98. One skilled in the art will appreciate that if the window buck 2 employs untreated lumber, a moisture resistant barrier must be placed between the exposed (i.e. non-insulated) wood portions of the window buck 2 and the concrete in accordance with the 2003 International Residential Code (IRC), Section R319.1. The exposed wood portions of the window buck 2 may be protected from concrete exposure by employing Gorilla Tape® sold by the Gorilla Glue Company of Cincinnati, Ohio. One or more adjustable bracing members 22 may also be included to prevent bowing of the lateral window buck members 14 and/or the upper buck member 6 and the lower buck member 10 when concrete is placed. The brace 18 is also included to maintain the substantially square shape of the window buck 2.

As shown, the strapping plates 82 are interconnected to the lateral window buck member 14 and a spacer web face 74. When the strap 98 is tensioned, the insulated concrete panel 42 will be securely fastened to the window buck 2. Concrete is subsequently placed into a void 122 between the two insulation panels 46 that make up the ICF 42. The rebar holder 102, which is positioned prior to introduction of concrete, is integrated by piercing the ends thereof into each insulation panel 46. Rebar 110 is then situated within the arcuate bends 106 of the rebar holder 102 and fastened thereto. It is important to note that the spacer webs 50 provided may also accommodate rebar 110 in a horizontal fashion. Once all of the rebar 110 is placed, concrete can be placed into the ICFs to form a concrete wall with insulation on either side thereof, thus providing superior thermal performance. One skilled in the art will appreciate that a rebar holder may be directly integrated into the individual buck members.

Referring now to FIGS. 1-13 a method of creating an insulated concrete wall panel 114 is provided. Initially, ICFs 42 are assembled to a height equal to or greater than the elevation of the rough buck opening minus the thickness of the engineered buck material 58, preferably about two inches. Next, the rough dimensions of the desired opening are obtained and the lateral buck members 14 are cut to a dimension of the rough opening height plus two inches. Since the thickness of the engineered buck material 58 is preferably about two inches, four inches is added to the dimension of the rough opening width and the engineered buck material that will become the upper buck member 6 is cut to that dimension. The lower buck member 10 is obtained from a length of the engineered buck material corresponding to the rough opening width. The top buck member 6 and bottom buck members 10 are then interconnected to the lateral buck members 14 to create a square or rectangular window buck 2. Fasteners, such as screws or nails, are used to interconnect the top buck member 6 and bottom buck member 10 to the lateral buck members 14, thereby creating a semi-rigid structure. If the wood portions of the window buck 2 are pressure treated, the fasteners must be hot-dipped, zinc-coated, galvanized steel, stainless steel, silicon bronze or copper to comply with the IRC. The window buck 2 may be maintained square by one or more corner braces 18 interconnected to a horizontal buck member 6 or 10 and a lateral buck member 14. After the buck members are sufficiently aligned, it is set atop the ICFs 42 that were previously placed.

The buck members are preferably interconnected to the ICFs 42 that are located adjacent thereto. This is accomplished by interconnecting strapping plates 82 onto the lateral members 14. The strapping plates 82 are, in one embodiment of the present invention, interconnected to the beams 30 of the engineered buck material 58. Next, the strap 98, preferably of woven polyester, is used to connect one strapping plate 82, which is connected to the beam 30 of the engineered buck material 58 to another strapping plate 82 that is connected to the other beam 30 of the engineered buck material. The straps 98 are of sufficient length to allow the excess to reside on either side of the window buck 2. That is, one strapping plate 82 will be required for both the inside and the outside of the buck 2. The strapping plates 82 must be spaced vertically according to form manufacturer requirements. A tab 90 positioned on the strapping plate 82 is adapted to receive the strap 98. The strapping plates 82 positioned on the lateral buck members also may help retain the ICFs generally in line with the front and back faces of the window buck and prevent bulging of the ICF when the concrete is placed. One skilled in the art will appreciate that this function may be provided by interconnected plates or brackets. Alternatively, such securing/aligning devices may be directly integrated into the buck members.

Next, an ICF 42 is placed adjacent to the lateral members 14 of the window buck 2. Additional strapping plates 82 are interconnected, via a screw, preferably, to the web faces 74 of the spacer webs 50 of the newly placed ICFs 42. Next, the excess strap that is located on either side of the buck is interconnected to the strapping plates 82 that are interconnected to the ICFs 42, via a buckle, for example. The straps 98 are then tensioned to remove any slack and firmly secure the insulated concrete forms 42 to the window buck 2. This step is repeated for the opposite side of the buck 2 thereby insuring that the insulated concrete form positioned on both sides of the buck 2 are securely interconnected thereto. Tensioning and strapping by hand has the benefit of centering the buck 2 in the width of the insulated concrete forms 42, preventing bulging of the ICF 42 at the buck 2, and providing lateral support of the lateral buck material 14.

As one skilled in the art will appreciate, often reinforcing, i.e. rebar 110, must be employed within the thickness of the concrete. Here, rebar 110 is cut to a length that meets the lapping requirements of the local building code or design specifications and placed within the void 122 between the two insulative panels 46 of the ICFs 42. Tie wire is preferably used to interconnect the rebar 110 to the rebar holder 102. One skilled in the art will appreciate that this process can be scaled as the wall is increased in width and in height. As the wall form increases in size, additional straps 98/strapping plates 82 may be required to further brace the forms prior to the introduction of concrete.

Prior to concrete placement, the straps 98 are checked for proper tension, while the strapping plates 82, corner bracing 18 and adjustable bracing 22 are also checked to ensure that the fasteners are secure. Next, concrete is placed into the void 122 between the insulative panels 46 of the ICFs 42. Immediately after concrete placement, any concrete debris is cleaned and removed from the adjustable bracing 22 and corner braces 18 to ensure that any locking mechanism integrated into the adjustable brace 22 may be released and the adjustable bracing 22 can move freely. In addition, the corner braces 18 are inspected for damage and/or stressing. After the concrete is sufficiently cured, the adjustable brace 22 is unfastened, cleaned and stored. The corner brace 18 is removed and inspected for damage or stressing, the strapping plates 82 are removed and the strap 98 is cut, removed and discarded. A reinforced concrete wall is thus created having insulation on the interior and exterior thereof that provides an opening for a window, or a door.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A preformed framing material for fabricating a top portion, a bottom portion and opposing lateral portions of a window or door opening, comprising:
a low density member;
beams interconnected to opposing sides of said low density member; and
a substantially planar interior material interconnected to said low density member and said beams.

2. The preformed framing material of claim 1, wherein said low density member includes at least one cavity positioned along an exterior surface, and wherein said substantially planar interior member is positioned opposite to said cavity.

3. The preformed framing material of claim 1, wherein said substantially planar interior material and said beams are comprised at least partially of wood.

4. The preformed framing material of claim 1, wherein said low density member is comprised of at least one of an expanded polystyrene, an extruded polystyrene, and a urethane.

5. The preformed framing material of claim 2, wherein said cavity spans the entire length of said low density member.

6. The preformed framing material of claim 2 wherein a cross section of said low density member is generally rectangular with said at least one cavity extending into an elongated side thereof such that said cavity possessed side walls and a floor.

7. The preformed framing material of claim 6 wherein said side walls are positioned about 90° to about 150° relative to said floor.

8. The preformed framing material of claim 6 wherein said side walls are interconnected to said floor by a fillet.

9. A preformed window buck for defining an opening within a wall, comprising:
an upper buck member that comprises:
an upper panel having a front edge, a rear edge, a left edge and a right edge,
a first beam interconnected to said upper panel adjacent to said front edge,
a second beam interconnected to said upper panel adjacent to said rear edge,
a first insulative material disposed between said first beam and said second beam and interconnected to said upper panel;
a lower buck member that comprises:
a lower panel having a front edge, a rear edge, a left edge and a right edge,
a third beam interconnected to said lower panel adjacent to said front edge,
a forth beam interconnected to said lower panel adjacent to said rear edge,
a second insulative material disposed between said third beam and said forth beam and interconnected to said lower panel;
a left lateral buck member that comprises:
a left lateral panel having a front edge, a rear edge, a left edge and a right edge,
a fifth beam interconnected to said left lateral panel adjacent to said front edge,
a sixth beam interconnected to said left lateral panel adjacent to said rear edge,
a third insulative material disposed between said fifth beam and said sixth beam and interconnected to said left lateral panel, wherein said left lateral buck member is interconnected to said upper buck member, adjacent to said left edge thereof, and to said lower buck member, adjacent to said left edge thereof;
a right lateral buck member that comprises:
a right lateral panel having a front edge, a rear edge, a left edge and a right edge,
a seventh beam interconnected to said right lateral panel adjacent to said front edge,
a eighth beam interconnected to said right lateral panel adjacent to said rear edge,
a forth insulative material disposed between said seventh beam and said eighth beam and interconnected to said right lateral panel, wherein said right lateral buck member is interconnected to said upper buck member, adjacent to said right edge thereof, and to said lower buck member, adjacent to said right edge thereof, and
wherein said interconnection of said upper buck member, said left lateral buck member, said right lateral buck member, and said lower buck member define a window buck such that the first, second, third and forth insulative members are positioned about an outside surface of said window buck.

10. The preformed window buck of claim 9, further comprising a brace interconnecting said upper panel and at least one of left lateral panel and said right lateral panel.

11. The preformed window buck of claim 9, further comprising an adjustable brace interconnected to said left lateral panel and said right lateral panel.

12. The preformed window buck of claim 9, wherein said first, second, third and forth insulative members each include a cavity adapted to receive concrete.

13. A wall, comprising:
a base of interconnected insulated concrete forms;
a window buck having upper, lower and lateral buck members, each comprised of a panel that supplies a first beam and a second beam with an insulative member therebetween, wherein said lower buck member is positioned on a top surface of said base;
lateral insulated concrete forms positioned on said base and adjacent to said lateral buck members;
upper insulated concrete forms positioned on said lateral insulated concrete forms and above said upper buck member; and
concrete positioned within said insulated concrete forms.

14. The wall of claim 13, wherein said lateral insulative concrete forms are associated with said lateral buck members via a strap.

15. The wall of claim 13, wherein at least one of said lateral buck members is interconnected to said upper buck member by a brace.

16. The wall of claim 13, wherein said lateral buck members are interconnected to each other by an adjustable brace.

17. A method for forming an opening using stackable, low-density foam blocks, comprising:
providing an upper buck member comprising a planar member with two beams interconnected thereto and with an insulating member positioned between said two beams;
providing a lower buck member comprising a planar member with two beams interconnected thereto and with an insulating member positioned between said two beams;
providing two lateral buck members interconnecting said upper buck member and said lower buck member to form a window opening, said lateral buck members comprising a planar member with two beams interconnected thereto and with an insulating member positioned between said two beams;
positioning a plurality of insulated concrete forms about said window opening, each insulated concrete form being defined by two insulation panels being separated by a spacer to provide a volume adapted for receiving concrete; and
introducing concrete into said volume.

18. The method of claim 17, further comprising interconnecting said lateral buck members with at least one adjustable brace.

19. The method of claim 17, further comprising incorporating reinforcing members with said low-density foam blocks.

20. The method of claim 19, wherein said reinforcing members are secured to a shaped holder disposed between walls of said low-density foam blocks.
